(19) United States
(12) Patent Application Publication
(10) Pub. No.: US 2014/0145928 A1
(43) Pub. Date: May 29, 2014

(54) ELECTRONIC APPARATUS AND DATA PROCESSING METHOD

(71) Applicant: KABUSHIKI KAISHA TOSHIBA, Tokyo (JP)

(72) Inventor: Takehiko Demiya, Ome-shi (JP)

(73) Assignee: KABUSHIKI KAISHA TOSHIBA, Tokyo (JP)

(21) Appl. No.: 13/765,226

(22) Filed: Feb. 12, 2013

(30) Foreign Application Priority Data
Nov. 28, 2012 (JP) 2012-260101

(51) Int. Cl. G06F 3/03

(52) U.S. Cl. CPC G06F 3/03
USPC 345/156

(57) ABSTRACT

According to one embodiment, an electronic apparatus includes a display processor, a determiner, and a presentation module. The display processor displays a plurality of strokes on a screen. The determiner determines whether a stroke for which a first process is executable exists in at least a part of a plurality of first strokes designated by a selected range on the screen. The presentation module presents to an user that the first process is executable, if it is determined that the stroke for which the first process is executable exists in at least the part of the plurality of first strokes.

### CROSS-REFERENCE TO RELATED APPLICATIONS

This application is based upon and claims the benefit of priority from Japanese Patent Application No. 2012-260101, filed Nov. 28, 2012, the entire contents of which are incorporated herein by reference.

### FIELD

Embodiments described herein relate generally to a technology which processes handwritten data.

### BACKGROUND

In recent years, various kinds of electronic apparatuses, such as a tablet, a PDA and a smart phone, have been developed. Most of these electronic apparatuses include touch-screen displays for facilitating input operations by users.

By touching a menu or an object, which is displayed on the touch-screen display, by a finger or the like, the user can instruct the electronic apparatus to execute a function which is associated with the menu or object.

However, most of existing electronic apparatuses with touch-screen displays are consumer products which are designed to enhance operability on various media data such as video and music, and are not necessarily suitable for use in a business situation such as a meeting, a business negotiation or product development. Thus, in business situations, paper-based pocket notebooks have still been widely used.

Recently, a technology for handling handwritten objects such as handwritten characters has been developed.

However, conventionally, a user interface for easily handling handwritten data is not considered.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic apparatus according to an embodiment;

FIG. 2 is an exemplary view illustrating a cooperative operation between the electronic apparatus of the embodiment and an external apparatus;

FIG. 3 is a view illustrating an example of a handwritten document which is handwritten on a touch-screen display of the electronic apparatus of the embodiment;

FIG. 4 is an exemplary view for explaining time-series information corresponding to the handwritten document of FIG. 3, the time-series information being stored in a storage medium by the electronic apparatus of the embodiment;

FIG. 5 is an exemplary block diagram illustrating a system configuration of the electronic apparatus of the embodiment;

FIG. 6 is an exemplary block diagram illustrating a functional configuration of a digital notebook application program which is executed by the electronic apparatus of the embodiment;

FIG. 7 is an exemplary view illustrating a graphical user interface display operation which is executed by the electronic apparatus of the embodiment during range select operation;

FIG. 8 is a view illustrating another example of the graphical user interface display operation which is executed by the electronic apparatus of the embodiment during range select operation;

FIG. 9 is a view illustrating still another example of the graphical user interface display operation which is executed by the electronic apparatus of the embodiment during range select operation;

FIG. 10 is an exemplary flowchart illustrating the procedure of a graphical user interface display process which is executed by the electronic apparatus of the embodiment during range select operation;

FIG. 11 is an exemplary view illustrating the graphical user interface display operation which is executed by the electronic apparatus of the embodiment during range select operation and a result of the process for a handwritten object part belonging to the selected range;

FIG. 12 is an exemplary view illustrating a process result corresponding to a case in which an adjacent handwritten object part is processed by considering that some handwritten stroke is shared by the handwritten object part in FIG. 11 and the adjacent handwritten object part; and

FIG. 13 is an exemplary view illustrating a process result corresponding to a case in which an adjacent handwritten object part is processed without considering that some handwritten stroke is shared by the handwritten object part in FIG. 11 and the adjacent handwritten object part.

### DETAILED DESCRIPTION

Various embodiments will be described hereinafter with reference to the accompanying drawings.

In general, according to one embodiment, an electronic apparatus includes a display processor, a determiner, and a presentation module. The display processor displays a plurality of strokes on a screen. The determiner determines whether a stroke for which a first process is executable exists in at least a part of a plurality of first strokes designated by a selected range on the screen. The presentation module presents to a user that the first process is executable, if it is determined that the stroke for which the first process is executable exists in at least the part of the plurality of first strokes.

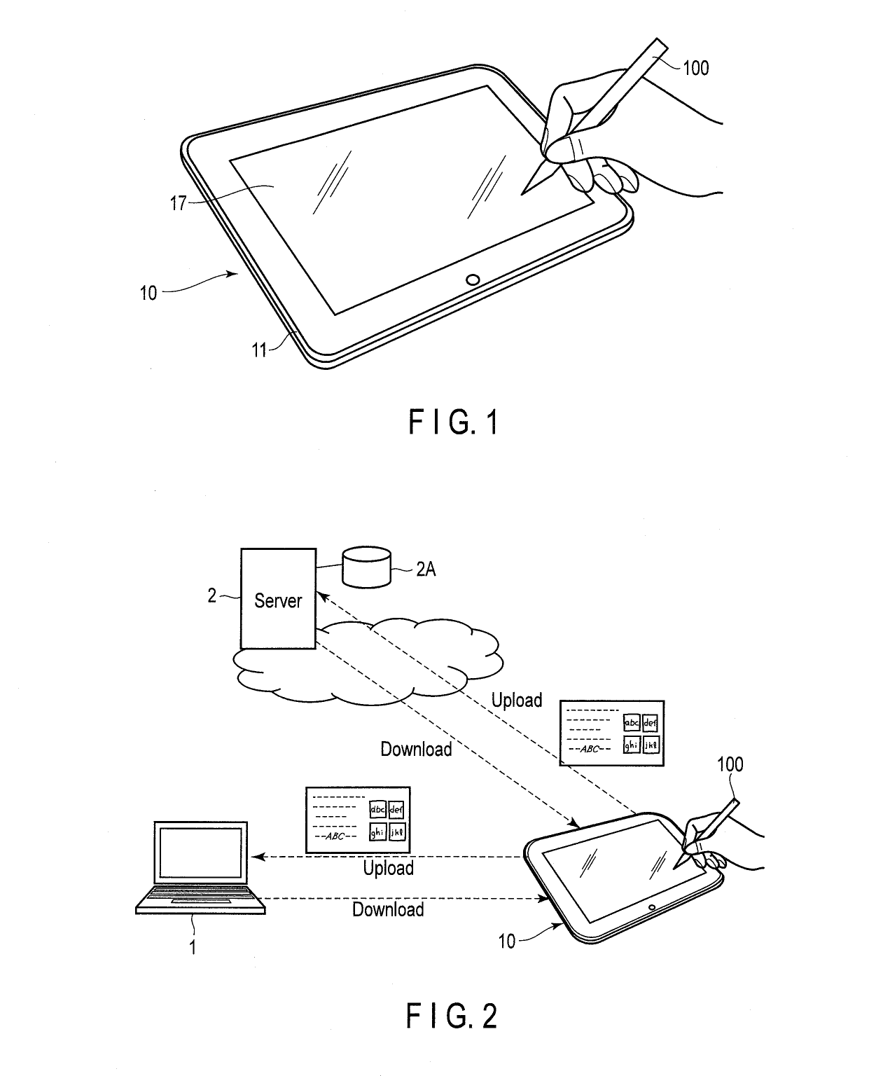

FIG. 1 is a perspective view illustrating an external appearance of an electronic apparatus according to an embodiment. The electronic apparatus is, for instance, a pen-based portable electronic apparatus which can execute a handwriting input by a pen or a finger. This electronic apparatus may be realized as a tablet computer, a notebook-type personal computer, a smart phone, a PDA, etc. In the description below, the case is assumed that this electronic apparatus is realized as a tablet computer 10. The tablet computer 10 is a portable electronic apparatus which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and the touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen. The user can execute a handwriting input operation on the touch-screen display 17 by using an external object (pen 100 or finger). During the handwriting input operation, a locus of movement of the external object (pen 100 or finger) on the screen, that is, a stroke (locus of a handwritten stroke) that is handwritten by the handwriting input operation, is drawn in real time, and thereby a plurality of handwritten strokes (locus of each handwritten stroke) input by handwriting are displayed on the screen. A locus of movement of the external object during a time in which the external object is in contact with the screen corresponds to one handwritten stroke. A set of many handwritten strokes corresponding to handwritten characters, marks, graphics or tables, that is, a set of many loci (traces of writing), constitutes a handwritten document. Hereinafter, a handwritten stroke may also be simply called a stroke.

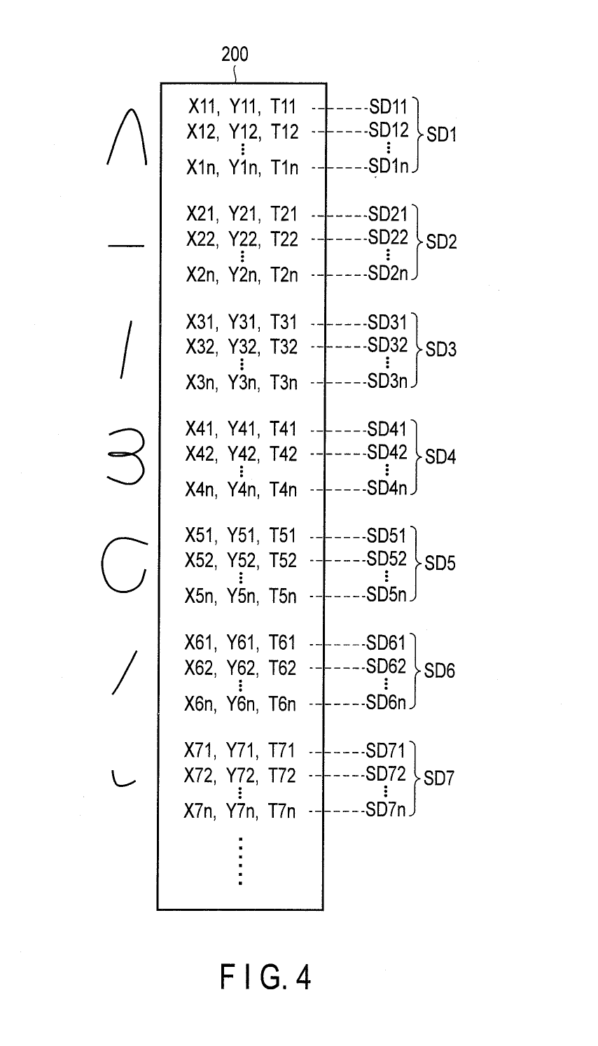

In the present embodiment, this handwritten document is stored in a storage medium not as image data but as time-series information indicative of coordinate series of the locus of each of strokes and the order relation between the strokes. The details of this time-series information will be described later with reference to FIG. 4. This time-series information indicates an order in which a plurality of strokes are handwritten, and includes a plurality of stroke data corresponding to the plurality of strokes. In other words, the time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes are handwritten, that is, an order of strokes.

The tablet computer 10 can read out arbitrary existing time-series information from the storage medium, and can display on the screen a handwritten document corresponding to this time-series information, that is, a plurality of strokes indicated by this time-series information. The strokes indicated by time-series information are also a plurality of strokes input by handwriting.

Furthermore, the tablet computer 10 has an edit function. The edit function can delete or move an arbitrary stroke or an arbitrary handwritten object part (a handwritten character, a handwritten mark, a handwritten graphic, a handwritten table, etc.) in the displayed handwritten document, in accordance with an edit operation by the user with use of an “eraser” tool, a range select tool, and other various tools. Further, this edit function can execute various functions, for example, a graphic reshaping function, a table reshaping function, a handwritten character recognition/reshaping function and the like on a handwritten object part belonging to a select range.

In this embodiment, the time-series information (handwritten document) may be managed as one page or plural pages. In this case, the time-series information (handwritten document) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

FIG. 2 shows an example of a cooperative operation between the tablet computer 10 and an external apparatus. The tablet computer 10 can cooperate with a personal computer 1 or a cloud. Specifically, the tablet computer 10 includes a wireless communication device of, e.g. wireless LAN, and can execute wireless communication with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit time-series information (handwritten document) to the personal computer 1 over a network, and can store the time-series information (handwritten document) in the HDD of the personal computer 1 (“upload”). In order to ensure a secure communication between the tablet computer 10 and personal computer 1, the personal computer 1 may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from the tablet computer 10 to the personal computer 1.

Thereby, even when the capacity of the storage in the tablet computer 10 is small, the tablet computer 10 can handle many time-series information (many handwritten documents) or large-volume time-series information (large-volume handwritten document).

In addition, the tablet computer 10 can read out (“download”) one or more arbitrary time-series information stored in the HDD of the personal computer 1, and can display the strokes indicated by the read-out time-series information on the screen of the display 17 of the tablet computer 10. In this case, the tablet computer 10 may display on the screen of the display 17 a list of thumbnails which are obtained by reducing in size pages of plural time-series information (handwritten documents), or may display one page, which is selected from these thumbnails, on the screen of the display 17 in the normal size.

Furthermore, the destination of communication of the tablet computer 10 may be not the personal computer 1, but the server 2 on the cloud which provides storage services, etc., as described above. The tablet computer 10 can transmit time-series information (handwritten document) to the server 2 over the network, and can store the time-series information (handwritten document) in a storage device 2A of the server 2 (“upload”). Besides, the tablet computer 10 can read out arbitrary time-series information which is stored in the storage device 2A of the server 2 (download) and can display the locus of each stroke, which is indicated by this time-series information, on the screen of the display 17 of the tablet computer 10.

As has been described above, in the present embodiment, the storage medium in which the time-series information is stored may be the storage device in the tablet computer 10, the storage device in the personal computer 1, or the storage device in the server 2.

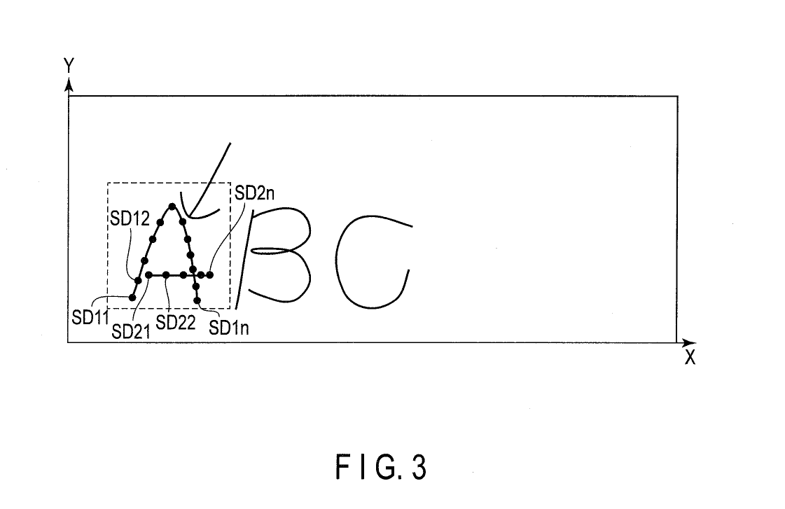

Next, referring to FIG. 3 and FIG. 4, a description is given of a relationship between strokes (characters, marks, graphics, tables, etc.), which are handwritten by the user, and time-series information. FIG. 3 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 3, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “A” shape, a locus of “-” shape) which are handwritten by using the pen 100 or the like, that is, by two loci. The locus of the pen 100 of the first handwritten “A” shape is sampled in real time, for example, at regular time intervals, and thereby time-series coordinates SD11, SD12, . . . , SD1n of the stroke of the “A” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information 200 corresponding to the handwritten document of FIG. 3. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes are handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the handwritten “Λ” shape of the handwritten character “A”, that is, an n-number of coordinate data SD11, SD12, . . . , SD1n. The stroke data SD2 includes coordinate data series corresponding to the points on the locus of the stroke of the handwritten “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “A” shape. The coordinate data SD1n is indicative of an X coordinate (X1n) and a Y coordinate (Y1n) of the end point of the stroke of the “Λ” shape.

Further, each coordinate data may include time stamp information T corresponding to a time point at which a point corresponding to this coordinate data was handwritten. The time point at which the point was handwritten may be either an absolute time (e.g. year/month/date/hour/minute/second) or a relative time with reference to a certain time point. For example, an absolute time (e.g. year/month/date/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

The time-series information 200 having the structure as described with reference to FIG. 4 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 3, the handwritten character “A” and the distal end portion of the handwritten “arrow” can be treated as different characters or graphics.

In addition, in the time-series information 200 of the present embodiment, as described above, the arrangement of stroke data SD1, SD2, . . . , SD7 is indicative of the order of strokes of handwritten characters. For example, the arrangement of stroke data SD1 and SD2 is indicates that the stroke of the “Λ” shape was first handwritten and then the stroke of the “-” shape was handwritten. Thus, even when the traces of writing of two handwritten characters are similar to each other, if the orders of strokes of the two handwritten characters are different from each other, these two handwritten characters can be distinguished as different characters.

Furthermore, in the present embodiment, as described above, a handwritten document is stored not as an image or a result of character recognition, but as the time-series information 200 which comprises a set of time-series stroke data. Thus, handwritten characters can be handled, without depending on languages of the handwritten characters. Therefore, the structure of the time-series information 200 of the present embodiment can be commonly used in various countries of the world where different languages are used.

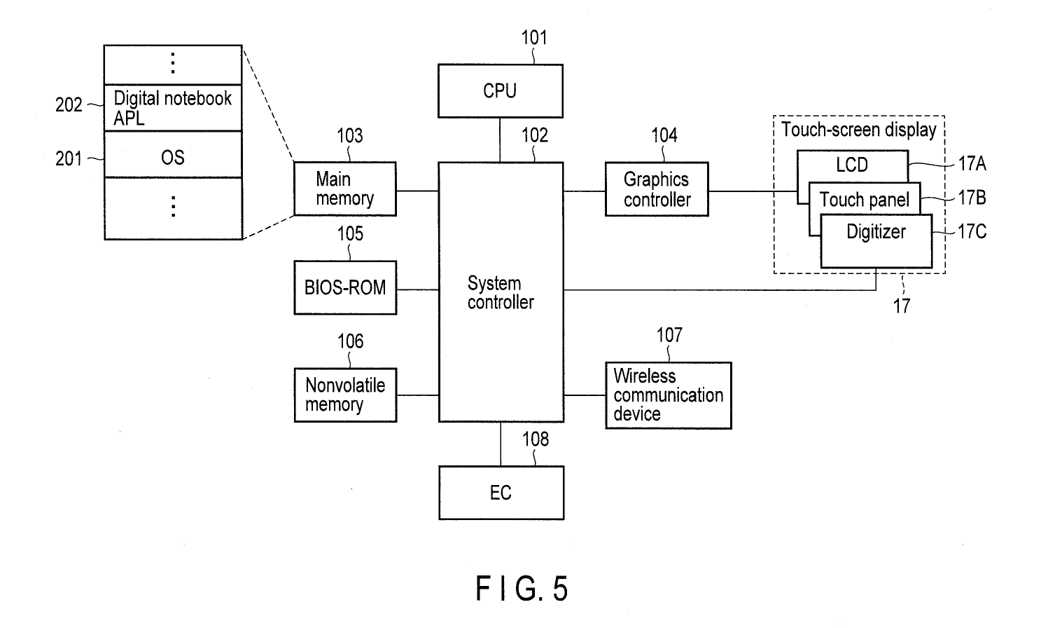

FIG. 5 shows a system configuration of the tablet computer 10. As shown in FIG. 5, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above handwritten document and a function to edit the handwritten document (including a reshaping function, a recognition function, etc.).

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal generated by the graphics controller 104 is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position, are detected by the touch panel 17B. The digitizer 17C is an electromagnetic induction-type pointing device for executing an input on the screen of the LCD 17A. A contact position on the screen, which is touched by the pen 100, and a movement of the contact position, are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of power on or power off the tablet computer 10 in accordance with an operation of a power button by the user.

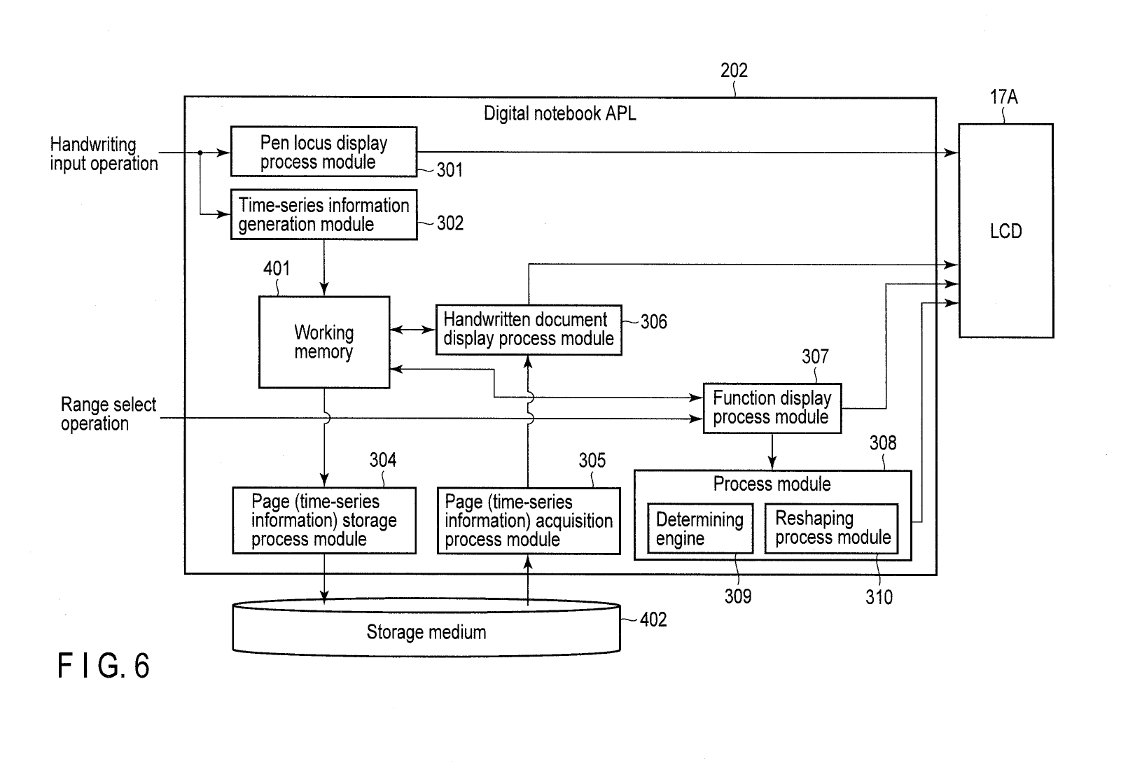

Next, referring to FIG. 6, a description is given of a functional configuration of the digital notebook application program 202.

The digital notebook application program 202 is a WYSIWYG application which is capable of handling handwritten data and includes a pen locus display process module 301, a time-series information generation module 302, a page storage process module 304, a page acquisition process module 305, a handwritten document display process module 306, a function display process module 307, and a process module 308.

The digital notebook application program 202 creates, displays, or edits a handwritten document by using stroke data input by using the touch screen display 17. The touch-screen display 17 is configured to detect the occurrence of events such as “touch”, “move (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The pen locus display process module 301 and time-series information generation module 302 receive an event “touch” or “move (slide)” which is generated by the touch-screen display 17, thereby detecting a handwriting input operation. The “touch” event includes coordinates of a contact position. The “move (slide)” event also includes coordinates of a contact position at a destination of movement. Thus, the pen locus display process module 301 and time-series information generation module 302 can receive coordinate series, which correspond to the locus of movement of the contact position, from the touch-screen display 17.

The pen locus display process module 301 functions a display processor configured to display a plurality of strokes input by handwriting on the screen of the LCD 17A in the touch-screen display 17. More specifically, the pen locus display process module 301 receives coordinate series from the touch-screen display 17 and displays, based on the coordinate series, each stroke corresponding to a handwritten object written by a handwriting input operation with use of the pen 100 or the like on the screen of the LCD 17A in the touch-screen display 17. By the pen locus display process module 301, the locus of the pen 100 during a time in which the pen 100 is in contact with the screen, that is, the locus of each stroke, is drawn on the screen of the LCD 17A.

The time-series information generation module 302 receives the above-described coordinate series which are output from the touch-screen display 17, and generates, based on the coordinate series, the above-described time-series information (set of stroke data) having the structure as described in detail with reference to FIG. 4. In this case, the time-series information, that is, the coordinates and time stamp information corresponding to the respective points of each stroke, may be temporarily stored in a working memory 401.

The page storage process module 304 stores the generated time-series information as a handwritten document (handwritten page) in a storage medium 402. The storage medium 402, as described above, may be the storage device in the tablet computer 10, the storage device in the personal computer 1, or the storage device in the server 2.

The page acquisition process module 305 reads out from the storage medium 402 arbitrary time-series information which is already stored in the storage medium 402. The read-out time-series information is sent to the handwritten document display process module 306. The handwritten document display process module 306 functions the display processor configured to display a plurality of strokes which are input by handwriting on a screen. The handwritten document display process module 306 analyzes the time-series information and displays, based on the analysis result, each stroke indicated by the time-series information (each stroke input by handwriting) on the screen as a handwritten page.

The function display process module 307 supports a range select operation executed by the user, by using a graphical user interface. The range select operation is an operation for selecting an arbitrary part in the handwritten page on the screen, that is, an arbitrary part in a handwritten object. The user can use, for example, the “range select” tool to surround an arbitrary part on the screen with a rectangular frame or a circular frame by operating the pen 100. The process module 308 can execute various functions such as the above-described reshaping and recognition on the handwritten object part belonging to the selected range surrounded with a rectangular frame or a circular frame.

To support the range select operation by the user, the function display process module 307 determines whether any stroke for which a specific process (first process) is executable exists in at least a part of a plurality of first strokes designated by the selected range on the screen during range select operation by using a determining engine 309. A stroke for which the first process can be executed is recognized as a significant object part.

If it is determined that a stroke for which the first process is executable exists in at least a part of the plurality of first strokes designated by the selected range during range select operation, the function display process module 307 presents to the user that the first process is executable through the graphical user interface.

If it is determined that a stroke for which the first process is executable exists in at least a part of the plurality of first strokes, the function display process module 307 may make a first graphical user interface part (for example, a button) to which the function for executing the first process is assigned selectable (enabled). In this case, the display form of the button may be changed from a non-selectable gray-out state to a selectable enabled state.

Alternatively, If it is determined that a stroke for which the first process is executable exists in at least a part of the plurality of first strokes, the function display process module 307 may display the first graphical user interface part (for example, a button) to which the function applicable to at least a part of the plurality of first strokes is assigned on the screen.

With this operation of the function display process module 307, when some part of a plurality of strokes input by handwriting, that is, some part of a handwritten object is selected, how far the selected range should be extended so that the function (edit function such as reshaping) of the digital notebook application program 202 becomes executable can be presented in a manner which allows the user to understand easily. The user can efficiently execute the range select operation by, for example, extending the selected range while viewing the graphical user interface.

In the process for determining whether any stroke for which the above first process is executable exists, that is, the process for determining whether the above significant handwritten object part exists, as described above, a plurality of first strokes designated by the selected range are used. Not only strokes contained wholly in the selected range, but also strokes contained partially in the selected range are used as the above first strokes. In other words, a plurality of strokes belonging to the selected range wholly or partially can be used as the plurality of first strokes which are designated by the selected range. That is, each of first strokes is at least partially contained in the selected range.

In the above-described determining process, whether any stroke for which the first process is executable exists in at least a part of the plurality of first strokes can be determined, based on a positional relationship between a plurality of the first strokes. Further, whether any stroke for which the first process is executable exists in at least a part of the plurality of first strokes may be determined, based on whether the plurality of first strokes form a handwritten object part in a closed shape in the selected range.

Another method may be used as the above-described determining process. For example, the function display process module 307 may first select a plurality of first stroke parts contained in a selected range from a plurality of first strokes designated by the selected range and determine whether any stroke for which the first process is executable exists, that is, whether a significant object part exists in the plurality of first stroke parts.

Now, the case is assumed that three strokes A, B, C whose parts belong to the selected range exist. That is, each of the three strokes A, B, C partially belong to the selected range. In this case, (1) data of a part (stroke part A1) inside the stroke A, the stroke part A1 being contained in the selected range, (2) data of a part (stroke part B1) inside the stroke B, the stroke part B1 being contained in the selected range, and (3) data of a part (stroke part C1) inside the stroke C, the stroke part C1 being contained in the selected range, can be used for the above determining process. The data of the stroke part A1, for example, is extracted from stroke data corresponding to the stroke A. That is, a part of coordinate series in the stroke data corresponding to the stroke A is used as the stroke data corresponding to the stroke part A1.

Then, based on the positional relationship between these stroke parts A1, B1, C1, whether any stroke for which the first process is executable exists, that is, whether a significant handwritten object part exists in at least a part of the plurality of first strokes designated by the selected range may be determined.

In this manner, whether any stroke for which the first process is executable exists in at least a part of a plurality of first strokes which are designated by the selected range is determined in the present embodiment. Thus, by considering not only strokes wholly belonging to the selected range, but also strokes partially belonging to the selected range, whether any stroke for which the first process is executable exists, that is, whether a significant object part exists can be determined. Therefore, whether any stroke for which the first process is executable exists can be determined even if the selected range is relatively small, in other words, without extending the selected range to such a size that one or more strokes are wholly contained.

For example, a handwritten table containing four elements (four cells) of 2 rows×2 columns can be written by handwriting three horizontal lines and three vertical lines. In this case, if the method of determining whether a significant handwritten object part exists by using only strokes wholly belonging to the current selected range is adopted, the existence of six strokes corresponding to three horizontal lines and three vertical lines cannot be considered as long as the whole handwritten table containing four elements of 2 rows×2 columns is not surrounded as a selected range. According to the present embodiment, only by surrounding one element (first element) of four elements of 2 rows×2 columns as the selected range, whether a significant handwritten object part exists in at least a part of, for example, four strokes constituting the first element can be determined. The first element is an element (one cell of a handwritten table) for which the reshaping function can be executed and thus, the first element is decided as a significant handwritten object part.

The process module 308 can execute, as described above, various functions, for example, the reshaping function, the recognition function and the like for a handwritten object part belonging to the selected range. The process module 308 includes the above determining engine 309 and a reshaping process module 310.

The determining engine 309 acquires a plurality of stroke data corresponding to the plurality of first strokes designated by the selected range from the function display process module 307. Then, based on the plurality of stroke data corresponding to the plurality of first strokes, the determining engine 309 determines whether any stroke for which the first process is executable exists in at least a part of the plurality of first strokes designated by the current selected range. For example, based on whether the plurality of first strokes form a handwritten object part in a closed shape in the selected range, the determining engine 309 may determine whether any stroke for which the first process is executable exists in at least a part of the plurality of first strokes. The handwritten object part having the closed shape is, for example, one cell in a handwritten table, a rectangular part in handwritten graphics, a circular part in handwritten graphics, etc.

The determining engine 309 may acquire, instead of the plurality of stroke data corresponding to the plurality of first strokes designated by the selected range, only plurality of stroke data corresponding to the plurality of first handwritten stroke parts contained in the selected range may be acquired from the function display process module 307. Since each stroke data contains, as described above, many coordinates, a plurality of coordinate series, which are included in the many coordinates contained and are contained in the selected range, become stroke data corresponding to the first handwritten stroke part. Then, based on stroke data of each of the plurality of first handwritten stroke parts, the determining engine 309 may determine whether a significant handwritten object part exists in a part of handwritten objects designated by the current selected range. If, for example, a handwritten object part formed by the plurality of first handwritten stroke parts in the current selected range contains the above handwritten object part having a closed shape, the determining engine 309 may determine that the handwritten object part having the closed shape is the above significant object part.

The reshaping process module 310 executes the above reshaping and recognition functions. That is, if the plurality of first strokes designated by the selected range forms a handwritten object part for which the first process is executable, the reshaping process module 310 functions as a handwritten object process module which reshapes the handwritten object part and outputs the reshaping result. Further, the reshaping process module 310 can recognize handwritten characters contained in the handwritten object part for which the first process can be executed and output the recognition result of handwritten characters.

As described above, a handwritten object part contained in the selected range may be selected from a handwritten object displayed on the screen and then, whether the significant handwritten object part exists in the handwritten object part may be determined. In this case, the reshaping process module 310 reshapes a significant handwritten object part in the selected range and outputs the reshaping result which corresponds to the significant handwritten object part.

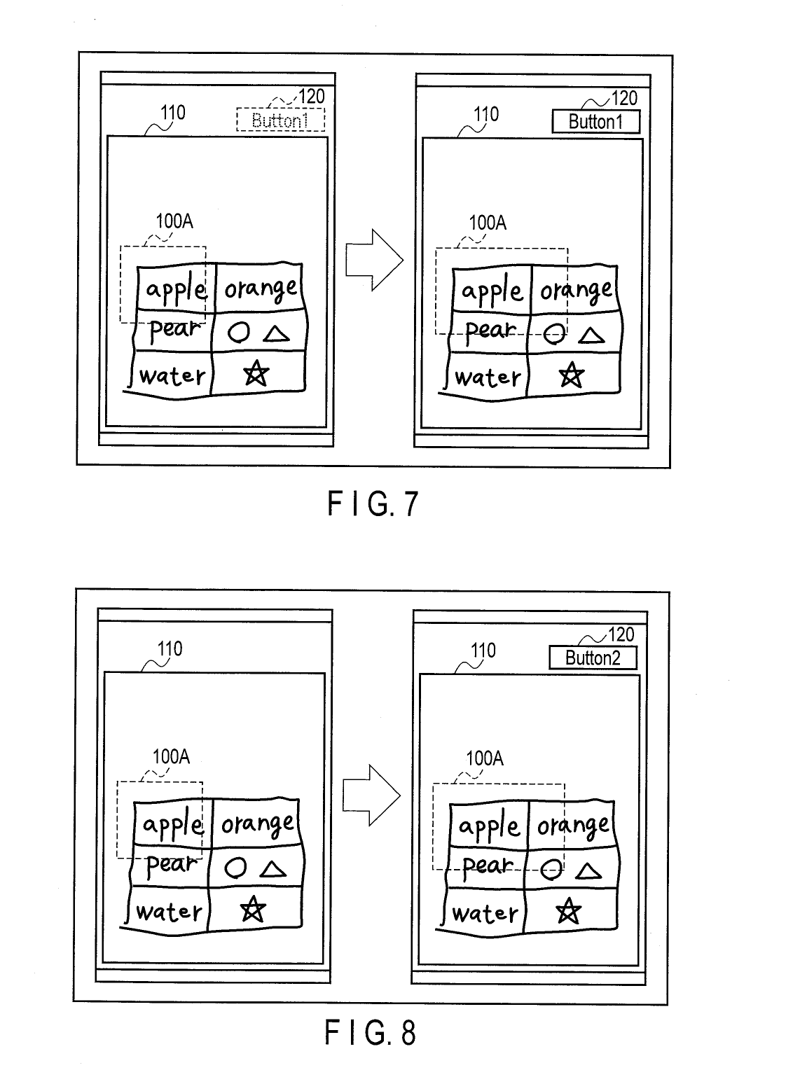

FIG. 7 shows an example of a graphical user interface display operation which is executed during range select operation. As described above, the digital notebook application program 202 determines whether any stroke for which the first process (the reshaping process, recognition process, or other various processes) is executable exists in at least a part a plurality of first strokes designated by the selected range which is designated by the user and, if the first process is executable, can present via the graphical user interface to the user that the first process is executable.

As shown on the left side of FIG. 7, a plurality of handwritten strokes constituting handwritten data are displayed in a drawing region 110 on the screen. The drawing region 110 is a region in which a handwritten stroke can be written. Naturally, a plurality of strokes may be displayed in the drawing region 110 based on a plurality of stroke data in handwritten data read out from a storage medium. Here, the case is assumed that a plurality of the strokes input by handwriting represent a handwritten table, and the handwritten table is displayed in the drawing region 110. In the case of a handwritten table, one cell of the table could become a significant handwritten object part.

When a range select operation is executed by the user, the current selected range is displayed on the screen by a rectangular select frame 100A. The shape of the select frame 100A is not limited to the rectangular shape and may be, for example, a circular shape. The user can execute a range select operation by moving, for example, the pen 100 from some point on the screen to another point. The start point of movement of the pen 100 becomes one vertex of the select frame 100A and the point at a destination of movement of the pen 100 becomes the diagonal vertex for the above vertex of the select frame 100A. The size of the select frame 100A increases with an increasing amount of movement of the pen 100. When the pen 100 is released from the screen, the range select operation is finished.

The left side of FIG. 7 shows a state in which data necessary for executing a specific function (first process) does not exist in the range (selected range) of the select frame 100A. At this point, “Button1” 120 to which the above specific function (first process) of the digital notebook application program 202 is assigned is presented to the user in a gray-out state which is a disabled state in which the “Button1” 120 cannot be selected and executed. As a user interface to prevent execution of a specific function (first process), other interfaces than a gray-out state may be used.

The right side of FIG. 7 is a case when the range (selected range) of the select frame 100A is further expanded than the state on the left side of FIG. 7 and shows a state in which data (a handwritten object part corresponding to one cell of the table, that is, a group of strokes corresponding to one cell of the table) necessary for executing the specific function (first process) exists in the selected range. At this point, as shown on the right side of FIG. 7, the “Button1” 120 assigned to the specific function (first process) changes to a selectable state after the gray-out state on the left side of FIG. 7 being reset. As method of activating a user interface for executing a specific function, other methods than the method of resetting the gray-out state may be adopted.

FIG. 8 shows another example of the graphical user interface display operation which is executed during range select operation. As described above, when significant data, for example, a cell in a handwritten table, a graphics part of a specific shape in handwritten graphics, or a handwritten character exists in the selected range, the digital notebook application program 202 can present content of functions executable on the handwritten data in the selected range to the user via the graphical user interface.

The left side of FIG. 8 shows a state in which data necessary for executing a function does not exist in the range (selected range) of the select frame 100A. At this point, no executable function exists and thus, no function is displayed. That no executable function exists for the selected range may be indicated to the user by other methods. The right side of FIG. 8 is a case when the selected range is further expanded from the state on the left side of FIG. 8 and shows a state in which a function executable by using a part of the handwritten object in the selected range exists. Here, “Button2” 120 to which a first function executable for a part of the handwritten object in the selected range is assigned is displayed on the screen. The name of the first function may be displayed on the “Button 2” 120.

In FIG. 8, an example of presenting only one button to which an executable function is assigned is shown, but when a plurality of executable functions exist, a plurality of buttons to which these functions are assigned may be presented to the user. Alternatively, one or more executable functions may be presented to the user by a user interface other than the button, like, for example, a menu.

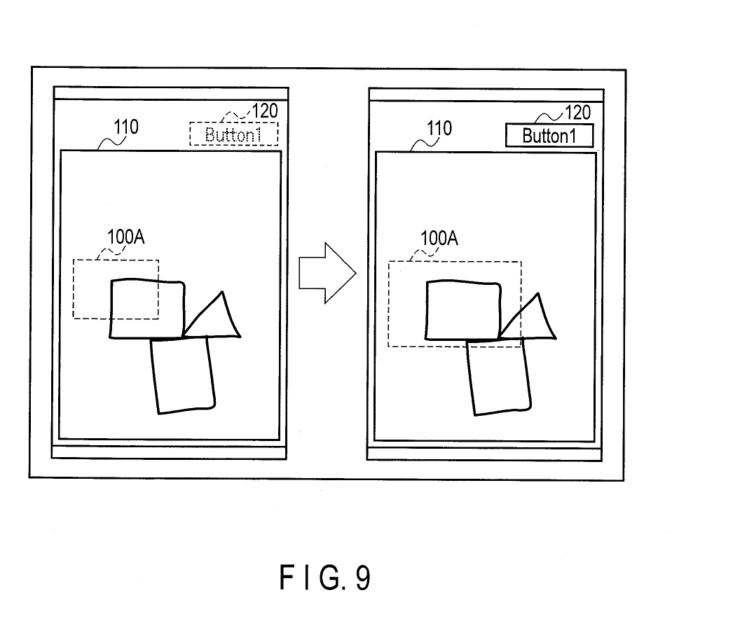

FIGS. 7 and 8 show a pattern of recognizing and reshaping one cell in a handwritten table, but, as shown in FIG. 9, an embodiment of reshaping a part of handwritten graphics can also be considered. An upper part of the handwritten graphics (graphics of the shape in which a quadrangular graphics part and a triangular graphics part are linked) of FIG. 9 is written by one or more strokes. As shown on the right side of FIG. 9, when the range (selected range) of the select frame 100A surrounds the quadrangular graphics part, strokes which correspond to the quadrangular graphics part can be determined as strokes for which the first process can be executed, that is, as a significant handwritten object part for which the reshaping function or the like can be executed. Then, for example, the “Button2” 120 to which the reshaping function or the like is assigned is enabled or the “Button2” 120 to which the reshaping function or the like is assigned is newly displayed on the screen.

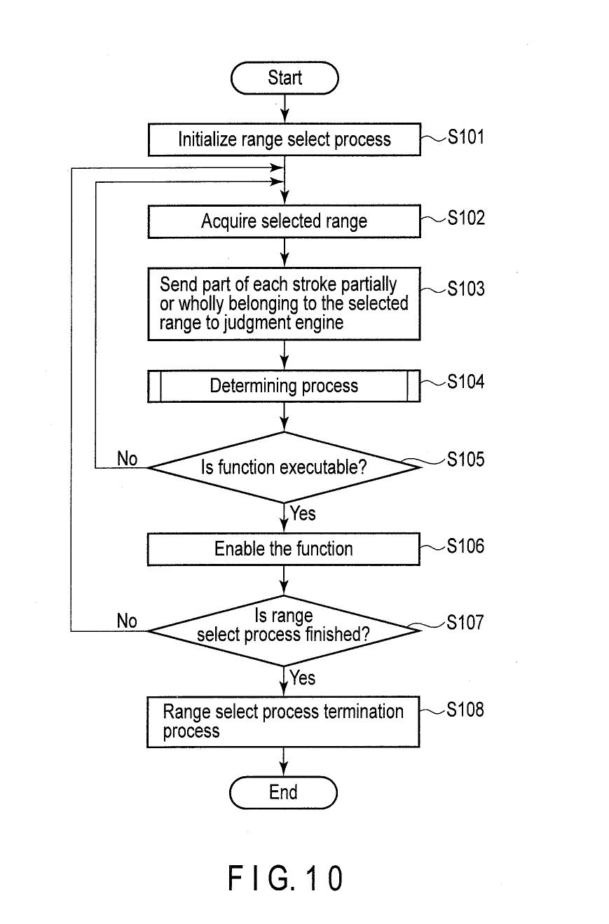

The flowchart of FIG. 10 shows the procedure of a graphical user interface display process executed by the digital notebook application program 202 during range select operation executed by the user.

The flowchart is a range select process subroutine for selecting a process-target part from handwritten data in accordance with a range select operation executed by the user. First, the digital notebook application program 202 initializes the range select process (step S101). Next, the digital notebook application program 202 detects that a range select operation of a handwritten object (one or more stroke data) is executed by the user. In this case, the function display process module 307 of the digital notebook application program 202 acquires the selected range (step S102). The function display process module 307 sends a plurality of stroke data corresponding to a plurality of first strokes (first handwritten strokes) designated by the current selected range to the determining engine 309 (step S103). In this case, the function display process module 307 can send at least a part of each of the plurality of first handwritten strokes belonging to the current selected range wholly or partially to the determining engine 309 (step S103). In step S103, the function display process module 307 may select a plurality of first handwritten stroke parts contained in the current selected range from the plurality of first handwritten strokes and send stroke data of the plurality of first handwritten stroke parts to the determining engine 309. Stroke data belonging to the selected range wholly, that is, strokes wholly contained in the selected range are all sent to the determining engine 309 as stroke data of the strokes. Regarding stroke data belonging to the selected range partially, that is, strokes partially contained in the selected range, only stroke data parts of parts contained in the selected range are sent to the determining engine 309.

The function display process module 307 may send stroke data of all strokes whose part belongs to the selected range at least partially and information indicating the selected range to the determining engine 309. In this case, the determining engine 309 may select the plurality of first handwritten stroke parts from all these strokes.

The determining engine 309 determines whether any stroke (significant handwritten object part) for which the first process is executable exists in at least a part of the plurality of first handwritten strokes designated by the selected range based on a plurality of stroke data corresponding to the plurality of received first handwritten strokes (step S104) and returns the result thereof to the function display process module 307. In step S104, the determining engine 309 may determine coordinates of each location where the plurality of first handwritten strokes cross, thereby identifying the shape of an object part formed by the plurality of first handwritten strokes in the selected range.

In step S104, based on, for example, stroke data of the plurality of received first handwritten stroke parts, the determining engine 309 may determine whether a significant handwritten object part for which the function of the digital notebook application program 202 is executable exists in a part of the handwritten object designated by the selected range, in other words, whether a function executable for handwritten object parts in the selected range exists. In this case, the determining engine 309 may determine coordinates of each location where first handwritten stroke parts cross, thereby identifying the shape of an object part formed by the first handwritten stroke parts in the selected range.

If a stroke (significant handwritten object part) for which the first process is executable exists in at least a part of the plurality of first handwritten strokes, for example, if a significant handwritten object part exists in the selected rage (YES in step S105), the function display process module 307 proceeds to the next step S106. On the other hand, if no significant handwritten object part exists in at least a part of the plurality of first handwritten strokes or in the selected range (NO in step S105), the function display process module 307 continues the range select process and acquires a new selected range (step S102). Accordingly, the above judgment is repeatedly made during range select operation executed by the user.

In step S106, the function display process module 307 enables the disabled function of the application program 202 or presents functions executable for at least a part of a plurality of first handwritten strokes to the user via the user interface (step S106). When the range select process continues (NO in step S107), the function display process module 307 continues the range select process and acquires a new selected range (step S102). Accordingly, the above judgment is repeatedly made during range select operation executed by the user.

If the range select process is finished (YES in step S107), the function display process module 307 executes a termination process of the range select process (step S108).

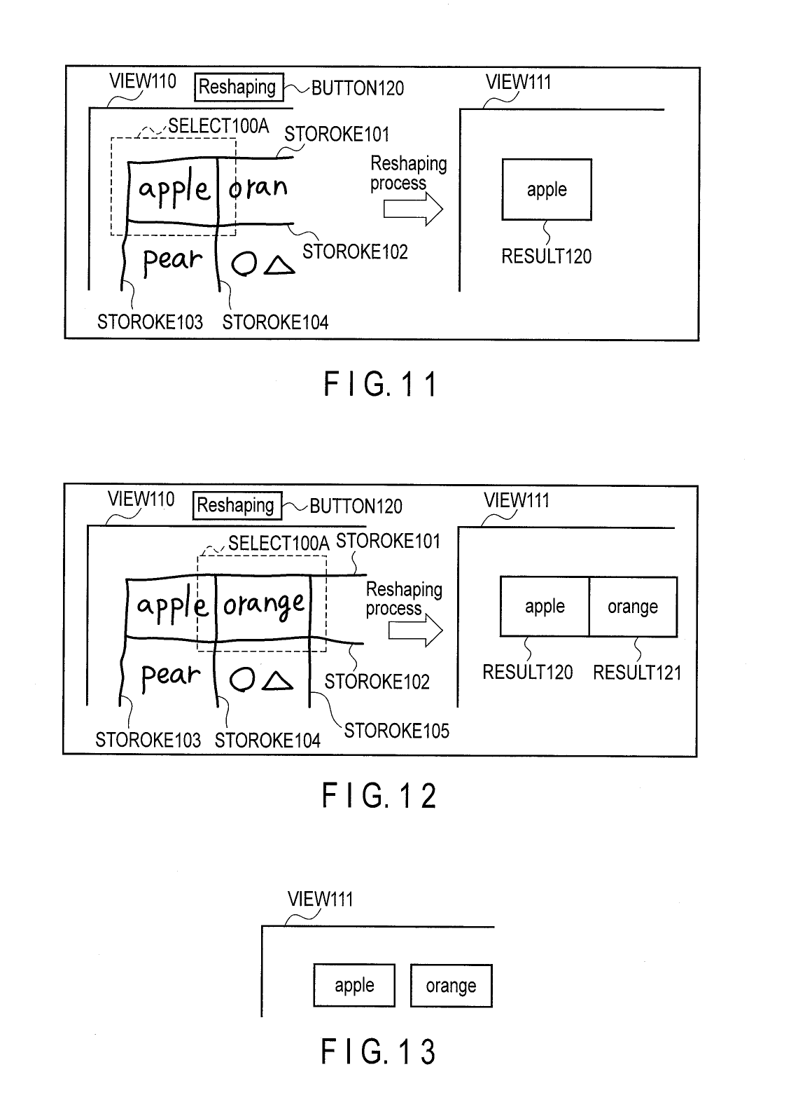

FIG. 11 shows an example of the graphical user interface display operation which is executed during range select operation and a result of the process for a handwritten object part in the selected range.

The “reshaping function” is cited here as an example of the function of the application program 202. A range select operation by the user is executed in a drawing region (VIEW110) where a handwritten stroke can be written. As described above, the shape of the select frame 100A is not limited to a rectangular shape and may be any closed shape which can surround a specific range. The following process is started when the select frame 100A in some closed shape is formed by a range select operation and executed each time an event is generated during range select operation or the timing arises.

The function display process module 307 of the application program 202 acquires a plurality of first strokes designated by the selected range surrounded by the select frame 100A and sends a plurality of stroke data corresponding to the plurality of first strokes to the determining engine 309. In this case, the function display process module 307 can acquire all strokes wholly belonging to the selected range and all strokes partially belonging to the selected range as the plurality of first strokes.

Alternatively, the function display process module 307 may acquire stroke data of all strokes wholly belonging to the selected range and stroke data of all strokes partially belonging to the selected range and select a plurality of first handwritten stroke parts contained in the selected range from the stroke data. Then, the function display process module 307 may send the plurality of first handwritten stroke parts to the determining engine 309.

In the example of FIG. 11, the function display process module 307 sends a plurality of stroke data corresponding to a plurality of strokes corresponding to handwritten strokes (in the example of FIG. 11, a handwritten character string read as “apple”) contained in the selected range surrounded by the select frame 100A and four stroke data corresponding to four handwritten strokes (STOROKE101, STOROKE102, STOROKE103, STOROKE104) partially contained in the selected range to the determining engine 309 and then requests the determining engine 309 to determine whether any stroke for which the first process is executable exists in at least a part of these strokes.

Instead of sending all four stroke data corresponding to four handwritten strokes (STOROKE101, STOROKE102, STOROKE103, STOROKE104) to the determining engine 309, the function display process module 307 may send only stroke data parts corresponding to stroke parts belonging to the selected range of the four handwritten strokes (STOROKE101, STOROKE102, STOROKE103, STOROKE104) to the determining engine 309. In this case, the function display process module 307 may request the determining engine 309 to determine whether a significant handwritten object exists in the selected range.

In the selected range surrounded by the select frame 100A, four stroke parts corresponding to the four handwritten strokes (STOROKE101, STOROKE102, STOROKE103, STOROKE104) are positioned in a manner to surround handwritten strokes (in the example of FIG. 11, a handwritten character string read as “apple”) contained in the selected range. That is, the four handwritten strokes (STOROKE101, STOROKE102, STOROKE103, and STOROKE104) are positioned in a manner to surround handwritten strokes (in the example of FIG. 11, a handwritten character string read as “apple”) in the selected range. Therefore, the determining engine 309 can determine a quadrangular part (part in a closed shape) formed by four stroke parts, that is, a quadrangular part (part in a closed shape) formed by STOROKE101, STOROKE102, STOROKE103, and STOROKE104 in the selected range as a significant object part for which the reshaping function can be executed. In other words, the determining engine 309 can determine that a cell part of the table where “apple” is written is reshapable by using the reshaping function.

The function display process module 307 receives a function ID indicating the “reshaping function” as an executable function from the determining engine 309. The function display process module 307 indicates to the user that the “reshaping function” is available by displaying a button (BUTTON120) to which the “reshaping function” is assigned on the screen or enabling the button (BUTTON120) disabled by gray-out. However, the method of indicating availability of the “reshaping function” to the user is not limited to the above methods.

If the range select operation by the user is finished by this point, a series of processes is completed without the judgment process being further repeated. No change is made to handwritten stroke data by a series of processes, and handwritten stroke data is not changed even if the “reshaping function” is used depending on the judgment result. However, this does not apply when a function involving a deletion or a modification of handwritten stroke data is executed.

How a judgment result is used will be described below. When the user uses the enabled “reshaping function”, for example, when the user presses the button 120 to which the reshaping function is assigned, the reshaping process module 310 executes a reshaping process for a significant object part in the selected range. The reshaping process module 310 displays a cell (RESULT120) containing characters “apple” in a region (VIEW111) for drawing a reshaping result (RESULT120). The cell is a part of the table. In RESULT120, a handwritten quadrangular part (part in a closed shape) formed by four stroke parts corresponding to four handwritten strokes (STOROKE101, STOROKE102, STOROKE103, STOROKE104) is reshaped into one cell (reshaped quadrangle) of the table and the handwritten character string “apple” is reshaped into character font series corresponding to the character recognition result (character code series) thereof. Then, one cell (reshaped quadrangle) of the table is drawn in VIEW111 and the character font series is drawn in one cell (reshaped quadrangle) of the table. In this manner, a handwritten object part in the selected range surrounded by the select frame 100A is converted into one cell of the table.

FIG. 12 shows a process executed when the range of area surrounding a cell of the handwritten table containing handwritten characters “orange” is newly selected after the process described with reference to FIG. 11.

The function display process module 307 of the application program 202 acquires, for example, stroke data of all strokes wholly belonging to the selected range surrounded by the select frame 100A and stroke data of all strokes partially belonging to the selected range and selects a plurality of first handwritten stroke parts contained in the selected range from the stroke data. Then, the function display process module 307 sends the plurality of first handwritten stroke parts to the determining engine 309.

In the example of FIG. 12, the function display process module 307 sends a group of stroke data corresponding to handwritten strokes (in the example of FIG. 12, a handwritten character string read as “orange”) contained in the selected range surrounded by the select frame 100A and stroke data of four stroke parts corresponding to four handwritten strokes (STOROKE101, STOROKE102, STOROKE104, STOROKE105) partially contained in the selected range to the determining engine 309 and then requests the determining engine 309 to determine whether a significant handwritten object exists in the selected range.

In the selected range surrounded by the select frame 100A, four stroke parts corresponding to the four handwritten strokes (STOROKE101, STOROKE102, STOROKE104, STOROKE105) are positioned in a manner to surround handwritten strokes (in the example of FIG. 12, a handwritten character string read as “orange”) contained in the selected range. Therefore, the determining engine 309 can determine that reshaping into one cell of the table where “orange” is written is possible by using the reshaping function.

The function display process module 307 receives a function ID indicating the “reshaping function” as an executable function from the determining engine 309. The function display process module 307 indicates to the user that the “reshaping function” is available by displaying a button (BUTTON120) to which the “reshaping function” is assigned on the screen or enabling the button (BUTTON120) disabled by gray-out.

When the user presses the button 120, the reshaping process module 310 executes a reshaping process for a significant object part in the selected range. In this case, based on stroke data of STOROKE104, the reshaping process module 310 can recognize that a stroke part corresponding to STOROKE104 is a boundary line between the cell of the handwritten table where “apple” is written and the cell of the handwritten table where “orange” is written.

Thus, when a first stroke part (stroke part corresponding to STOROKE104) as a part of a handwritten object part (cell of the table where “orange” is written) to be reshaped is one stroke part of a reshaped handwritten object part (cell of the table where “apple” is written), the reshaping process module 310 outputs the reshaping result (result121) of the cell of the table where “orange” is written so that the reshaping result of the first stroke part corresponding to STOROKE104 is shared between the reshaping result (result121) of the cell of the table where “orange” is written and the reshaping result (result120) of the cell of the table where “apple” is written. Therefore, as shown in FIG. 12, the number of boundary lines between result120 and result121 can be limited to only one. If the fact that a partial stroke (first stroke part) of STOROKE104 is a part of a partial stroke group of a reshaped handwritten object is not taken into consideration, as shown in FIG. 13, two reshaping results (result120, result121) independent of each other may be displayed.

In the present embodiment, as described above, a plurality of strokes which are input by handwriting are displayed on the screen. Then, whether any stroke for which the first process is executable exists in at least a part of a plurality of first strokes which are designated by the selected range on the screen is determined. Then, if a stroke for which the first process is executable is judged to exist in at least a part of the plurality of first strokes, that the first process is executable is presented to the user. Therefore, when a part in a handwritten object existing in a handwritten page being displayed is selected, to which part to expand the selected range to be able to execute a function can be presented to the user in a manner which allows the user to understand easily so that handwritten data can be handled easily.

Further, as described above, whether any stroke for which the first process is executable exists in at least a part of a plurality of first strokes designated by the selected range is determined. Thus, by considering not only strokes wholly belonging to the selected range, but also strokes partially belonging to the selected range, whether any stroke for which the first process is executable exists, that is, whether a significant object part exists can be determined. Therefore, whether any stroke for which the first process is executable exists can be determined even if the selected range is relatively small, in other words, without extending the selected range to such a size that one or more strokes are wholly contained. Therefore, whether a significant handwritten object part exists in the selected range can be determined precisely and also a significant handwritten object part in the selected range can be detected efficiently. Therefore, processes such as reshaping can efficiently be executed for cells as a part of a handwritten table.

Incidentally, processes in the present embodiment may also be applied to strokes like a cursive character string. In this case, strokes like a cursive character string, for example, a recognizable character or the like exist in at least a part of a plurality of first strokes designated by the selected range may be determine. Alternatively, a stroke part belonging to the selected range may be selected from strokes like a cursive character string, and whether a significant handwritten object part, for example, a recognizable character or the like exists in the stroke part may be determined.

A group of strokes (handwritten object parts) like a handwritten “arrow” described with reference to FIG. 3 judged to be less related to other strokes may be identified from among all strokes wholly or partially belonging to the selected range to execute a function such as the reshaping function after such a group of strokes being excluded. Accordingly, an intended reshaping process result can be obtained even if not only desired handwritten object parts, but also undesired handwritten object parts are contained in the selected range.

In the description of FIGS. 11 and 12, reshaping process results are displayed in VIEW111, but reshaping process results may also be displayed in VIEW110. In this case, in VIEW110 of FIG. 11, the handwritten quadrangular part (part in a closed shape) surrounding a handwritten character string which can be read as “apple” may be replaced by the reshaping result (RESULT120).

Various processes for a handwritten document according to the present embodiment can be realized by a computer program. Thus, the same advantageous effects as with the present embodiment can easily be obtained simply by installing the computer program into an ordinary computer through a computer-readable storage medium which stores the computer program, and by executing the computer program.

The function of the determining engine 309 and functions such as reshaping and recognition may be executed by the server 2.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display processor configured to display a plurality of strokes on a screen;
a determiner configured to determine whether any stroke for which a first process is executable exists in at least a part of a plurality of first strokes designated by a selected range on the screen; and
a presentation module configured to present to an user that the first process is executable, if it is determined that the stroke for which the first process is executable exists in at least the part of the first strokes.

2. The electronic apparatus of claim 1, wherein the determiner is configured to determine whether any stroke for which the first process is executable exists in at least the part of the first strokes, based on a positional relationship between the first strokes.

3. The electronic apparatus of claim 1, wherein the determiner is configured to determine whether any stroke for which the first process is executable exists in at least the part of the first strokes, based on whether the first strokes form a handwritten object part in a closed shape in the selected range.

4. The electronic apparatus of claim 1, wherein the presentation module makes a first graphical user interface to which a first function for executing the first process is assigned selectable when it is that the stroke for which the first process is executable exists in at least the part of the first strokes.

5. The electronic apparatus of claim 1, wherein the presentation module is configured to display a first graphical user interface to which functions applicable to at least the part of the first strokes on the screen is assigned when it is determined that the stroke for which the first process is executable exists in at least the part of the first strokes.

6. The electronic apparatus of claim 1,
wherein the determiner executes the determining repeatedly during a range select operation executed by the user, and
wherein the presentation module presents to the user that the first process is executable when it is determined that the stroke for which the first process is executable exists in at least the part of the first strokes.

7. The electronic apparatus of claim 1, further comprising: a handwritten object process module configured to reshaping, when the first strokes form a handwritten object part for which the first process is executable in the selected range, the handwritten object part to output a result of the reshaping.

8. The electronic apparatus of claim 7, wherein the handwritten object process module is further configured to recognize handwritten character contained in the handwritten object part to output a result of the recognition.

9. The electronic apparatus of claim 7, wherein when a first stroke part as a part of the handwritten object part is a stroke part of another reshaped handwritten object part, the handwritten object process module outputs a first reshaping result corresponding to the handwritten object part, wherein the first reshaping result shares the reshaping result of the first stroke part with the reshaping result of the other handwritten object part.

10. A data processing method comprising:
displaying a plurality of strokes on a screen;
determining whether any stroke for which a first process is executable exists in at least a part of a plurality of first strokes designated by a selected range on the screen; and
presenting to an user that the first process is executable, if it is determined that the stroke for which the first process is executable exists in at least the part of the first strokes.

11. A computer-readable, non-transitory storage medium having stored thereon a computer program which is executable by a computer, the computer program controlling the computer to execute functions of:
displaying a plurality of strokes on a screen;
determining whether any stroke for which a first process is executable exists in at least a part of a plurality of first strokes designated by a selected range on the screen; and
presenting to an user that the first process is executable, if it is determined that the stroke for which the first process is executable exists in at least the part of the first strokes.
